(19) United States
(12) Patent Application Publication
(10) Pub. No.: US 2026/0293801 A1
(43) Pub. Date: Oct. 1, 2026

(54) ADJUSTABLE MOWER ASSEMBLY

(71) Applicant: Textron Inc., Providence, RI (US)

(72) Inventor: Brian David Wanta, North Augusta, SC (US)

(73) Assignee: Textron Inc., Providence, RI (US)

(21) Appl. No.: 19/097,118

(22) Filed: Apr. 1, 2025

(51) Int. Cl. A01D 34/53; A01D 34/00; A01D 34/47; A01D 34/54; A01D 34/58; A01D 101/00

(52) U.S. Cl. CPC A01D 34/53; A01D 34/001; A01D 34/008; A01D 34/475; A01D 34/54; A01D 34/58; A01D 2101/00

(57) ABSTRACT

A mower assembly includes a housing and a cutting reel rotatably coupled to the housing. The cutting reel includes a shaft removably coupled to the housing, a plurality of supports coupled to and spaced along the shaft, and a plurality of blades coupled to and extending between the plurality of supports. Each blade of the plurality of blades is spaced a blade distance away from an adjacent blade of the plurality of blades The cutting reel is selectively adjustable between a first state and a second state such that the blade distance in the first state is less than the blade distance in the second state.

### BACKGROUND

Mowers (e.g., a lawnmower, a turf mower, a push mower, a ride-on mower, a stand-on mower) have a mower assembly for cutting vegetation. The mower assembly may vary dependent on type and height of the vegetation to be cut.

### SUMMARY

One embodiment relates to a mower assembly. The mower assembly includes a housing and a cutting reel rotatably coupled to the housing. The cutting reel includes a shaft removably coupled to the housing, a plurality of supports coupled to and spaced along the shaft, and a plurality of blades coupled to and extending between the plurality of supports. Each blade of the plurality of blades is spaced a blade distance away from an adjacent blade of the plurality of blades. The cutting reel is selectively adjustable between a first state and a second state such that the blade distance in the first state is less than the blade distance in the second state.

Another embodiment relates to a cutting reel for use in a mower. The cutting reel includes a shaft configured to rotatably couple to a housing of the mower, a plurality of support disks coupled to and spaced along the shaft, and a plurality of blades coupled to and extending between the plurality of support disks. Each of the plurality of supports disks have a plurality of interfaces positioned around a periphery thereof. A portion of each of the plurality of blades engages with one of the interfaces of each of the plurality of support disks. The plurality of support disks are configured to expand and retract to facilitate adjusting a blade spacing between the plurality of blades.

Still another embodiment relates to a mower. The mower includes a chassis, a tractive element coupled to the chassis, and a mower assembly coupled to the chassis. The mower assembly includes a housing and a cutting reel. The cutting reel includes a shaft rotatably coupled to the housing, a plurality of supports coupled to and spaced along the shaft, and a plurality of blades coupled to and extending between the plurality of supports. Each of the plurality of supports have a plurality of interfaces positioned around a periphery thereof A portion of each of the plurality of blades engages with one of the interfaces of each of the plurality of supports. The plurality of support disks are configured to expand and retract to facilitate adjusting a blade spacing between the plurality of blades.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a is schematic block diagram of a site monitoring and control system including a plurality of the vehicles of FIG. 1, according to an exemplary embodiment.

FIG. 4 is a perspective view of a cutting reel of the vehicle of FIG. 1 in a first state, according to an exemplary embodiment.

FIG. 5 is a perspective view of the cutting reel of the vehicle of FIG. 4 in a second state, according to an exemplary embodiment.

FIG. 6 is a detailed view of a support of the cutting reel of FIG. 4 in a first configuration, according to an exemplary embodiment.

FIG. 7 is a detailed view of the support of FIG. 6 in a second configuration, according to an exemplary embodiment.

FIG. 8 is a detailed view of the support of FIG. 6 in a third configuration, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

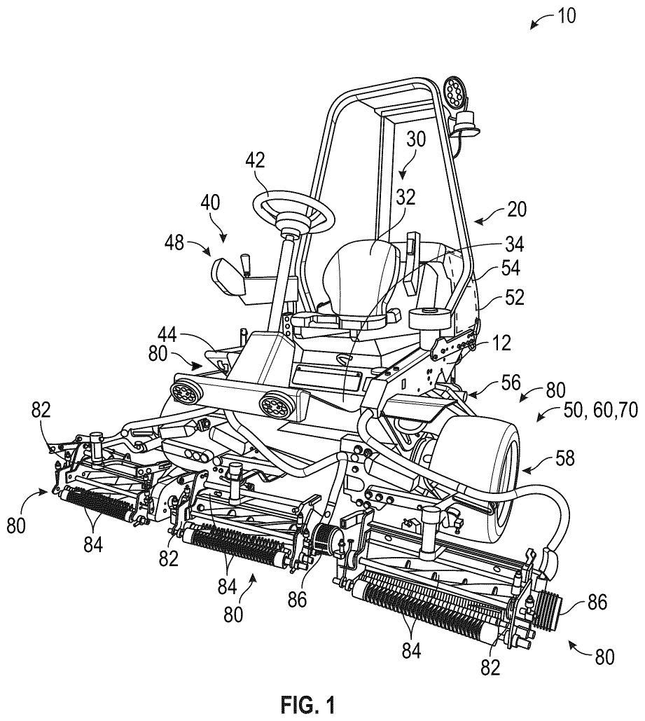

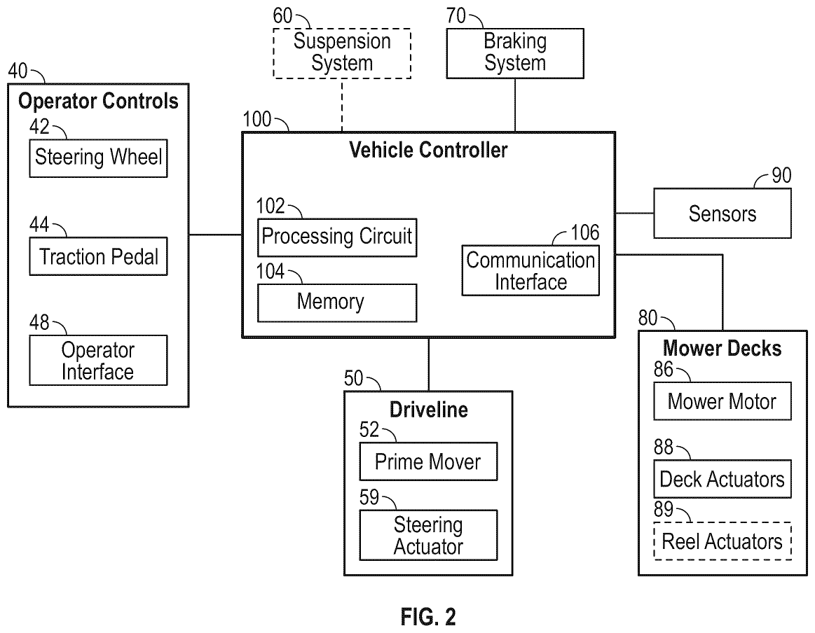

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; a series of implements, mower assemblies, or cutting units, shown as mower decks 80; one or more sensors, shown as sensors 90; and a vehicle control system, shown as vehicle controller 100, coupled to the operator controls 40, the driveline 50, the suspension system 60, the braking system 70, the mower decks 80, and the sensors 90. In other embodiments, the vehicle 10 includes more or fewer components.

According to an exemplary embodiment, the vehicle 10 is an off-road machine or vehicle. As shown in FIG. 1, the vehicle 10 is configured as a mower (e.g., a lawnmower, a turf mower, a push mower, a ride-on mower, a stand-on mower, or another type of mower). In other embodiments, the off-road machine or vehicle is a lightweight or recreational machine or vehicle such as a golf cart, golf cars, an all-terrain vehicle (“ATV”), a utility task vehicle (“UTV”), and/or another type of lightweight or recreational machine or vehicle. In some embodiments, the off-road machine or vehicle is a chore product such as aerator, turf sprayer, bunker rake, and/or another type of chore product (e.g., that may be used on a golf course).

According to the exemplary embodiments shown in FIG. 1, the occupant seating area 30 includes a single seat, shown as driver seat 32. In some embodiments, the occupant seating area 30 includes additional seats (e.g., a passenger seat, an additional row of seats, etc.). According to the exemplary embodiments shown in FIG. 1, the driver seat 32 is laterally centered on the body 20 and facing forward. In some embodiments, the driver seat 32 is facing rearward or otherwise positioned. In some embodiments, the occupant seating area 30 is omitted (e.g., the vehicle 10 is configured as a push mower). A portion of the frame 12 defines a platform, deck, or standing area, shown as operator platform 34. The operator platform 34 may extend forward of the driver seat 32 such that the occupant can rest their feet on the operator platform 34 while seated in the driver seat 32. The operator platform 34 may support the occupant as the occupant enters or exits the driver seat 32.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower a mower deck 80, etc.). As shown in FIGS. 1 and 2, the operator controls 40 include a steering interface (e.g., a steering wheel, joystick(s), etc.), shown steering wheel 42, an accelerator interface and/or braking interface (e.g., a pedal, a throttle, etc.), shown as traction pedal 44, and one or more additional interfaces, shown as operator interface 48. The steering wheel 42 may be used by an operator to indicate a desired steering direction of the vehicle 10. The traction pedal 44 may be used to control the speed and direction of travel of the vehicle 10. By way of example, pressing the traction pedal 44 in a first direction may cause the driveline 50 to move the vehicle 10 forward, and pressing the traction pedal 44 in an opposing section direction may cause the driveline 50 to move the vehicle 10 rearward. Returning the traction pedal 44 to a middle or neutral position may cause the braking system 70 and/or the driveline 50 to slow or stop the vehicle 10 or to hold the vehicle 10 in place. Alternatively, the operator interface 48 may include a pair of handles that act as a steering interface and control the driveline 50 in a zero-turn configuration (e.g., a left joystick to control the left side of the driveline 50 and a right joystick to control a right side of the driveline 50). The operator interface 48 may be used to control operation of the mower decks 80 (e.g., changing a cutting speed of a mower deck 80, changing a cutting height of a mower deck 80, etc.). The operator interface 48 may include one or more displays and one or more input devices. The one or more displays may be or include a touchscreen, an LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is one or more electric motors and the energy storage 54 is a battery system. In some embodiments, the driveline 50 is a fuel cell electric driveline whereby the prime mover 52 is one or more electric motors and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiments shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks. In some embodiments, the driveline 50 is omitted, and the vehicle 10 is propelled by an operator (e.g., the vehicle 10 is configured as a push mower).

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., based on an input from the steering wheel 42 and using a steering actuator 59 that controls the orientation of one or more wheels). In some embodiments, both the rear tractive assembly 56 and the front tractive assembly 58 are fixed and not steerable (e.g., employ skid steer operations). By way of example, the driveline 50 may include a hydrostatic transmission that permits independent driving of the left and right sides of the driveline 50.

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, the driveline 50 is a hydrostatic transmission that performs braking by using hydraulic motors to oppose movement of the tractive elements.

Referring to FIG. 1, the vehicle 10 includes a series of mower decks 80 (e.g., cutting units). Each mower deck 80 includes a deck, housing, or enclosure, shown as housing 82, and a cutting element 84 (e.g., a blade, a flail, a reel, etc.) movably coupled to the housing 82. Specifically, the cutting elements 84 are configured as reels that each rotate about a substantially horizontal axis.

Referring to FIG. 1, the housing 82 may open downward to expose the cutting element 84 to vegetation below the housing 82. A motor or actuator (e.g., an electric motor, a hydraulic motor, etc.), shown as mower motor 86, is coupled to the housing 82 and drives movement (e.g., rotation, oscillation, etc.) of the cutting element 84. While driven by the mower motor 86, the cutting element 84 crushes, mulches, removes, or otherwise trims vegetation beneath the housing 82. Alternatively, the cutting element 84 may be driven by the prime mover 52 (e.g., through a power take off).

As shown in FIG. 2, the vehicle 10 includes one or more linear actuators or height adjustment actuators, shown as deck actuators 88, each coupled to the frame 12 and to one or more of the mower decks 80. The deck actuators 88 permit control over a height of the corresponding mower deck 80 relative to the frame 12. The deck actuators 88 may set a cutting height of the mower deck 80. The cutting height represents a final height of vegetation that is trimmed by the mower deck 80. The deck actuators 88 may move the mower deck 80 to a travel position above the cutting height, in which the mower deck 80 is moved out of engagement with the vegetation and the ground surface. The travel position may be used when the vehicle 10 is traveling between job sites and/or the user does not wish to be trimming vegetation.

The sensors 90 may include various sensors positioned about the vehicle 10 to acquire vehicle information or vehicle data regarding operation of the vehicle 10, or the location thereof. The sensors 90 may include various sensors positioned about the vehicle 10 to acquire environment data regarding the environment surrounding the vehicle 10. By way of example, the sensors 90 may include an accelerometer, a gyroscope, a compass, a position sensor (e.g., a GPS sensor, an RTK sensor, etc.), an inertial measurement unit (“IMU”), suspension sensor(s), wheel sensors, an audio sensor or microphone, a camera, an optical sensor, a proximity detection sensor, linear potentiometers, and/or other sensors to facilitate acquiring vehicle information, vehicle data, or environment data regarding operation of the vehicle 10, the location thereof, and/or the surrounding environment. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

As shown in FIG. 2, the vehicle controller 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle controller 100 includes a processing circuit 102, a memory 104, and a communication interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle controller 100 represents a collection of processing devices. In such cases, the processing circuit 102 represents the collective processors of the devices, and the memory 104 represents the collective storage devices of the devices.

In one embodiment, the vehicle controller 100 is configured to selectively engage, selectively disengage, control, or otherwise communicate with components of the vehicle 10 (e.g., via the communication interface 106, a controller area network (“CAN”) bus, etc.). According to an exemplary embodiment, the vehicle controller 100 is coupled to (e.g., communicably coupled to) components of the operator controls 40 (e.g., the steering wheel 42, the traction pedal 44, the brake 46, the operator interface 48, etc.), components of the driveline 50 (e.g., the prime mover 52), components of the braking system 70, the mower decks 80, the deck actuators 88, and the sensors 90. By way of example, the vehicle controller 100 may send and receive signals (e.g., control signals, location signals, etc.) with the components of the operator controls 40, the components of the driveline 50, the components of the braking system 70, the sensors 90, and/or remote systems or devices (via the communication interface 106 as described in greater detail herein).

The communication interface 106 facilitate communications (e.g., wired or wireless communications) between the vehicle 10 and other devices (e.g., other of the vehicles 10, the user sensors 220, the user portal 230, the remote systems 240, etc.). By way of example, the communication interface 106 may be configured to employ one or more types of wireless communications protocols including Bluetooth, Wi-Fi, radio, cellular, and/or other suitable wireless communications protocols.

### Site Monitoring and Control System

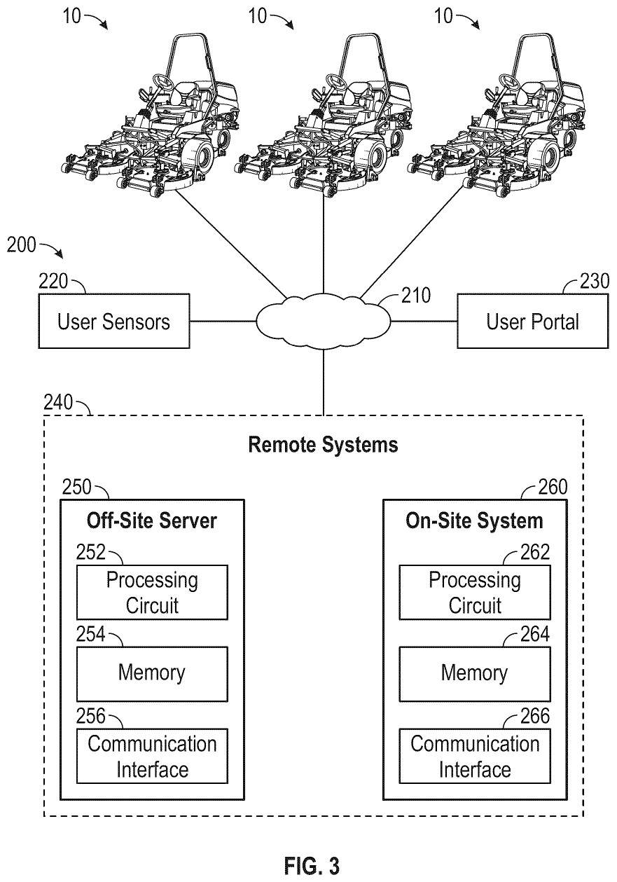

As shown in FIG. 3, a monitoring and control system, shown as site monitoring and control system 200, includes one or more vehicles 10; one or more second sensors, shown as user sensors 220, positioned remote or separate from the vehicles 10; an operator interface, shown as user portal 230, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210 (e.g., using the communication interface 106).

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, hear rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc.; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons braking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). The user portal 230 may be or may be accessed via a computer, laptop, smartphone, tablet, or the like.

As shown in FIG. 3, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 3, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle controllers 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Mower Assembly

As described herein, the mower deck 80 includes the housing 82 and the cutting element 84. The mower deck 80 is configured to cut or trim vegetation (e.g., grass, weeds, etc.). The mower deck 80 allows a user of the vehicle 10 to evenly cut the vegetation. Additionally, different features on the cutting element 84 may be adjustable dependent on the vegetation to be cut. For example, a blade height of the cutting element 84 may be adjusted dependent on a height of the vegetation. In another example, a spacing of blades of the cutting element 84 may be adjusted dependent on a type of vegetation (e.g., golf greens, sports fields, fairway, rough, etc. etc.).

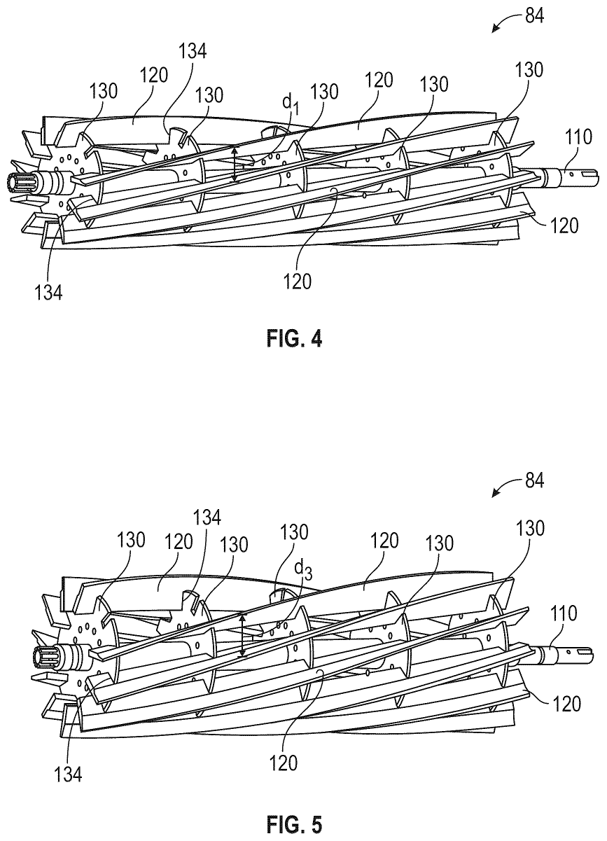

As shown in FIGS. 4 and 5, the cutting element 84 is configured as a cutting reel. The cutting element 84 may have a height that is set or adjustable. An adjustable height of the cutting element 84 allows for the vegetation to be cut to a specific length. The cutting element 84 is adjustable (e.g., selectively adjustable) between a first or retracted state, shown in FIG. 4, and a second or expanded state, shown in FIG. 5. In various embodiments, as is shown in FIG. 7, the cutting element 84 is selectively adjustable into at least one third or intermediate state between the retracted state and the expanded state. The adjustability of the cutting element 84 as described herein allows for a user of the vehicle 10 to adjust the cutting element 84 dependent on an environment in which the vehicle 10 is being operated in or to provide desired cut characteristics.

According to an exemplary embodiment, the cutting element 84 is rotatably coupled to the housing 82. As shown in FIGS. 4 and 5, the cutting element 84 includes a longitudinal rod, shown as shaft 110, that removably couples to the housing 82. In various embodiments, the shaft 110 is has a fixed length when coupled to the housing 82. In various embodiments, the shaft 110 includes features or elements (e.g., grooves, splines, keys, openings, interfaces. Etc.) to facilitate coupling the shaft 110 to the housing 82 and/or the mower motor 86.

As shown in FIGS. 4-8, the cutting element 84 includes a plurality of supports, shown as support disks 130. As shown in FIGS. 4 and 5, the support disks 130 are coupled to and spaced along the shaft 110. In various embodiments, the support disks 130 are spaced an equal distance apart along the shaft 110. The support disks 130 define a central aperture, shown as center opening 132, having a diameter D₁ through which the shaft 110 extends. The support disks 130 have a disk-like shape. During operation of the vehicle 10, the support disks 130 rotate with the shaft 110 to facilitate cutting operations.

As shown in FIGS. 4 and 5, the cutting element 84 includes a plurality of blades, shown as blades 120. The blades 120 are coupled to and extend between the support disks 130. As shown in FIGS. 4-8, the support disks 130 include a plurality of interfaces, shown as blade interfaces 134, positioned around a periphery of the support disks 130. As shown in FIGS. 4 and 5, the blades 120 engage with one of the blade interfaces 134 of each of the support disks 130. In other words, each of the blade interfaces 134 receive a portion of one of the blades 120. In some embodiments, the blade interfaces 134 are or include slots, bolts, pins, clamps, etc. such that the blades 120 can be coupled (e.g., removably coupled) to the support disks 130. In some embodiments, the blades 120 are fixedly coupled (e.g., welded) to the support disks 130. As shown in FIGS. 4 and 5, the blades 120 have a twisted, helical, or spiral design or shape such that the blades 120 are at least partially rotated about the shaft 110. In other embodiments, the blades 120 are substantially straight. The blades 120 may have a curved and/or angled edge to aid in cutting. The shaft 110 defines a longitudinal axis about which the blades 120 rotate around during operation of the mower deck 80.

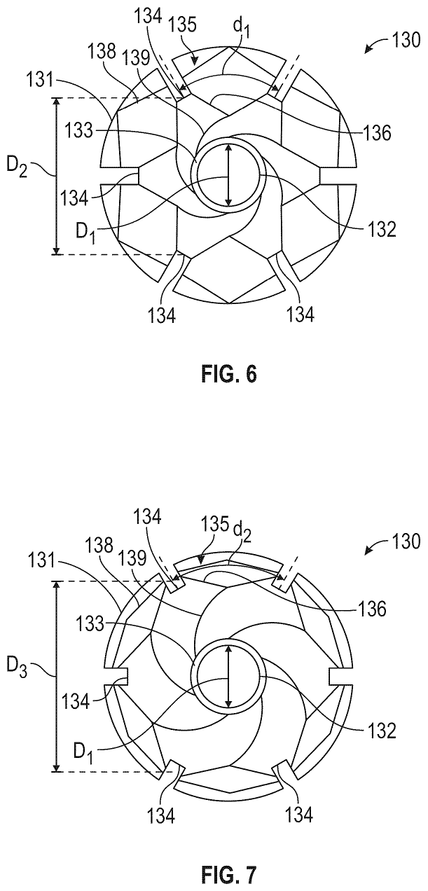

According to the exemplary embodiment shown in FIG. 4, the cutting element 84 is arranged or configured in the retracted state. In the retracted state, each of the blades 120 is positioned a first or minimum blade distance d₁ away from an adjacent blade of the blades 120. In various embodiments, the minimum blade distance d₁ is equal for all of the blades 120. As shown in FIG. 6, the support disk 130 is arranged in a retracted configuration that provides a minimum diameter D₂ of the blades 120 of the cutting element 84 when the cutting element 84 is in the retracted state, which provides the minimum blade distance d₁ between the blades 120.

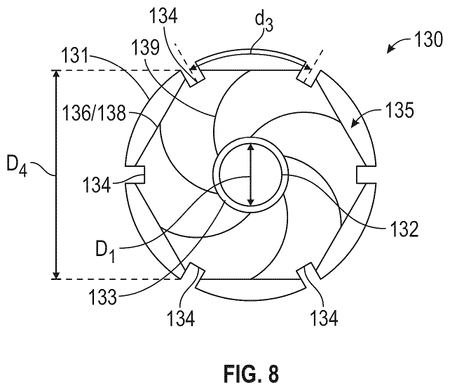

According to the exemplary embodiment shown in FIG. 5, the cutting element 84 is arranged or configured in the expanded state. In the expanded state, each of the blades 120 is positioned a third or maximum blade distance d₃ away from an adjacent blade. The maximum blade distance d₃ at the expanded state is greater than the minimum blade distance d₁ at the retracted state. The support disks 130 may expand and retract to facilitate adjust the blade distances. For example, expansion of the support disks 130 adjusts the cutting element 84 towards the expanded state and the blades 120 towards having the maximum blade distance d₃. Retraction of the support disks 130 adjusts the cutting element 84 towards the retracted state and the blades 120 towards having the minimum blade distance d₁. As shown in FIG. 8, the support disk 130 is arranged in an expanded configuration that provides a maximum diameter D₄ of the blades 120 of the cutting element 84 when the cutting element 84 is in the expanded state, which provides the maximum blade distance d₃ between the blades 120. The maximum diameter D₄ is greater than the minimum diameter D₂. This change in the diameter of the support disks 130 and the cutting element 84 plays a role in changing the blade distance of the blades 120 between the retracted state and the expanded state.

As shown in FIG. 7, the support disk 130 is arranged in an intermediate configuration that provides an intermediate diameter D₃ of the blades 120 of the cutting element 84 when the cutting element 84 is in the intermediate state, which provides the intermediate blade distance d₃ between the blades 120. The intermediate blade distance d₂ and the intermediate diameter D₃ are between (a) the minimum blade distance d₁ and the maximum blade distance d₃ and (b) the minimum diameter D₂ and the maximum diameter D₄, respectively.

In various embodiments, adjustment between the retracted state and the expanded state may be done by applying a force on the cutting element 84. For example, a force on the cutting element 84 in a first direction can move the cutting element 84 towards the retracted state. The force on the cutting element 84 in an opposing second direction can move the cutting element 84 towards the expanded state. In various embodiments, the force is a rotational force applied about the longitudinal axis defined by the shaft 110. In various embodiments, the shaft 110 may include an apparatus to facilitate applying the force.

Adjustment of the cutting element 84 between the retracted state and the expanded state is configured such that the cutting element 84 does not have to be removed from the mower deck 80 to adjust between the states. In various embodiments, the cutting element 84 has a constant longitudinal length in the retracted state and in the expanded state. This allows for the cutting element 84 to not adjust the configuration of the mower deck 80 or require removement and/or addition of parts to adjust between the retracted state and the expanded state.

As shown in FIGS. 6-8, the support disks 130 include a base, shown as disk plate 131, a support ring, shown as inner support ring 133, positioned at the center of the disk plate 131, around the center opening 132, and a linkage mechanism, shown as linkage assembly 135 (e.g., a Hoberman mechanism), extending between the inner support ring 133, and the blades 120 within the blade interfaces 134 of the disk plate 131. According to an exemplary embodiment, the inner support ring 133 is rotationally coupled to the disk plate 131 such that rotation thereof causes the linkage assembly 135 to expand and retract, causing the blades 120 to translate along the blade interfaces 134 towards and away from the center opening 132, thereby facilitating adjustment of the support disks 130 to reconfigure the cutting element 84 between the retracted state and the expanded state. The rotation of the inner support ring 133 can be selectively fixed or locked to set a desired blade diameter of the cutting elements 84.

As shown in FIGS. 6-8, the linkage assembly 135 includes a plurality of linkages, shown as linkages 136, linkages 138, and linkages 139, that aid in expanding and contracting the support disks 130 to adjust the blade distance between the blades 120. More specifically, (a) each the linkages 139 is pivotably coupled to the inner support ring 133 and an adjacent set of the linkages 136, (b) each of the linkages 136 is pivotably coupled to one of the blades 120, and (c) each of the linkages 138 is pivotably coupled to one of the blades 120 and an adjacent linkage 138 coupled to an adjacent one of the blades 120. In response to rotation of the inner support ring 133, the linkages 139 drive the linkages 136, which causes the blades 120 to move along the blade interfaces 134 of the disk plate 131 and, therefore, the linkages 138 to move accordingly to expand and retract the cutting element 84.

In various embodiments, as shown in FIG. 2, the mower deck 80 includes a series of linear actuators or adjustment actuators, shown as reel actuator 89. The reel actuator 89 may be coupled to the mower deck 80 (e.g., the housing 82 and/or the cutting element 84) and facilitate adjusting the cutting element 84 between the retracted state and the expanded state (e.g., by rotating the inner support rings 133). The reel actuator 89 can set a blade distance of the blades 120. The reel actuator 89 and the deck actuators 88 may be used separately or in combination. The reel actuator 89 can be at least one of manually powered, electrically powered, or hydraulically powered. For example, the reel actuator 89 can be manually powered and the mower deck 80 can include a crank actuator to control the blade distance of the blades 120. In another example, the reel actuator 89 can be electrically powered and the mower deck 80 can include a motor to aid in controlling the blade distance of the blades 120.

As described herein, the reel actuator 89 may be coupled (e.g., communicatively coupled) to the vehicle controller 100 to control the reel actuator 89 and the cutting element 84 with the vehicle controller 100. The vehicle controller 100 may send and receive signals with components of the vehicle 10. For example, the vehicle controller 100 can be configured to receive an input from the communication interface 106. In various embodiments, the input may be information related to a desired blade distance, a desired state of the cutting element 84, etc. The reel actuator 89 can adjust the blade distance of the blades 120 based on the input.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the vehicle controller 100, etc.) as shown in the various exemplary embodiments is illustrative only. Additionally, any element disclosed in one embodiment may be incorporated or utilized with any other embodiment disclosed herein.

1. A mower assembly comprising:
a housing; and
a cutting reel rotatably coupled to the housing, the cutting reel including:
a shaft removably coupled to the housing;
a plurality of supports coupled to and spaced along the shaft; and
a plurality of blades coupled to and extending between the plurality of supports, each blade of the plurality of blades spaced a blade distance away from an adjacent blade of the plurality of blades;
wherein the cutting reel is selectively adjustable between a first state and a second state; and
wherein the blade distance in the first state is less than the blade distance in the second state.

2. The mower assembly of claim 1, wherein the plurality of supports have a diameter that is greater in the second state than in the first state.

3. The mower assembly of claim 2, wherein each of the plurality of supports has a disk-like shape.

4. The mower assembly of claim 2, wherein each of the plurality of supports includes a Hoberman mechanism.

5. The mower assembly of claim 1, wherein the cutting reel is selectively adjustable into at least one intermediate state between the first state and the second state, and wherein the blade distance in the at least one intermediate state is between the blade distance in the first state and the second state.

6. The mower assembly of claim 1, wherein a force on the cutting reel in a first direction moves the cutting reel towards the first state and the force on the cutting reel in an opposing second direction moves the cutting reel towards the second state.

7. The mower assembly of claim 6, wherein the force is a rotational force applied about a longitudinal axis defined by the shaft.

8. The mower assembly of claim 1, wherein the cutting reel has a length along a longitudinal axis, the length in the first state equal to the length in the second state.

9. The mower assembly of claim 1, wherein each of the plurality of supports defines a plurality of interfaces positioned around a periphery thereof, and wherein each of the plurality of interfaces receives a portion of one of the plurality of the blades.

10. The mower assembly of claim 1, wherein the plurality of blades are arranged in a helical-like pattern around the shaft.

11. The mower assembly of claim 1, further comprising an actuator coupled to the housing, the actuator configured to facilitate adjusting the cutting reel between the first state and the second state.

12. The mower assembly of claim 11, wherein the actuator is at least one of manually powered, electrically powered, or hydraulically powered.

13. The mower assembly of claim 11, further comprising:
an operator interface;
a controller coupled to the operator interface and the actuator, the controller configured to:
receive an input from the operator interface; and
control the actuator based on the input to adjust the blade distance.

14. A cutting reel for use in a mower, the cutting reel comprising:
a shaft configured to rotatably couple to a housing of the mower;
a plurality of support disks coupled to and spaced along the shaft, each of the plurality of supports disks having a plurality of interfaces positioned around a periphery thereof; and
a plurality of blades coupled to and extending between the plurality of support disks, a portion of each of the plurality of blades engaging with one of the interfaces of each of the plurality of support disks;
wherein the plurality of support disks are configured to expand and retract to facilitate adjusting a blade spacing between the plurality of blades.

15. The cutting reel of claim 14, wherein a first rotational force applied to the cutting reel in a first direction expands the plurality of support disks and a second rotational force applied to the cutting reel in an opposing second direction retracts the plurality of support disks.

16. The cutting reel of claim 14, wherein each of the plurality of support disks includes a Hoberman mechanism.

17. The cutting reel of claim 14, further comprising an actuator configured to cause expansion and retraction of the plurality of support disks.

18. The cutting reel of claim 17, wherein the actuator is at least one of manually powered, electrically powered, or hydraulically powered.

19. A mower comprising:
a chassis;
a tractive element coupled to the chassis; and
a mower assembly coupled to the chassis, the mower assembly including:
a housing; and
a cutting reel including:
a shaft rotatably coupled to the housing;
a plurality of supports coupled to and spaced along the shaft, each of the plurality of supports having a plurality of interfaces positioned around a periphery thereof; and
a plurality of blades coupled to and extending between the plurality of supports, a portion of each of the plurality of blades engaging with one of interfaces of each of the plurality of supports;
wherein the plurality of support disks are configured to expand and retract to facilitate adjusting a blade spacing between the plurality of blades.

20. The mower of claim 19, further comprising an actuator coupled to the mower assembly, the actuator configured to facilitate adjusting the support disks to expand and retract.
